(19) United States
(12) Patent Application Publication
(10) Pub. No.: US 2015/0181618 A1
(43) Pub. Date: Jun. 25, 2015

(54) EARLY ABORT OF SCHEDULING INFORMATION (SI) RETRANSMISSION

(71) Applicant: QUALCOMM INCORPORATED, SAN DIEGO, CA (US)

(72) Inventors: Ming YANG, San Diego, CA (US); Tom CHIN, San Diego, CA (US); Guangming SHI, San Diego, CA (US)

(73) Assignee: QUALCOMM INCORPORATED, SAN DIEGO, CA (US)

(21) Appl. No.: 14/139,722

(22) Filed: Dec. 23, 2013

(51) Int. Cl. H04W 72/12; H04L 29/06

(52) U.S. Cl. CPC H04W 72/1231; H04W 72/1278; H04L 69/03

(57) ABSTRACT

A user equipment may improve throughput between the user equipment and a nodeB by reducing a delay associated with transmitting new scheduling information. In some instances, when scheduling information changes during or prior to the retransmission of the previous scheduling information, the user equipment aborts a retransmission of the previous scheduling information and initiates a new scheduling information transmission using a scheduling grant received at the time of aborting or after the time of aborting.

### TECHNICAL FIELD

Aspects of the present disclosure relate generally to wireless communication systems, and more particularly, to improved scheduling information (SI) retransmission.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining whether current scheduling information (SI) is outdated based on a comparison of content of the current SI and actual user equipment (UE) observations. The method also includes aborting a retransmission of the current SI when the current SI is determined to be outdated. The method further includes transmitting a new SI instead of retransmitting the outdated SI.

According to another aspect of the present disclosure, an apparatus for wireless communication includes means for determining whether current scheduling information (SI) is outdated based on a comparison of content of the current SI and actual user equipment (UE) observations. The apparatus also includes means for aborting a retransmission of the current SI when the current SI is determined to be outdated. The apparatus further includes means for transmitting a new SI instead of retransmitting the outdated SI.

According to one aspect of the present disclosure, a computer program product for wireless communication in a wireless network includes a computer readable medium having non-transitory program code recorded thereon. The program code includes program code to determine whether current scheduling information (SI) is outdated based on a comparison of content of the current SI and actual user equipment (UE) observations. The program code also includes program code to abort a retransmission of the current SI when the current SI is determined to be outdated. The program code further includes program code to transmit a new SI instead of retransmitting the outdated SI.

According to one aspect of the present disclosure, an apparatus for wireless communication includes a memory and a processor(s) coupled to the memory. The processor(s) is configured to determine whether current scheduling information (SI) is outdated based on a comparison of content of the current SI and actual user equipment (UE) observations. The processor(s) is also configured to abort a retransmission of the current SI when the current SI is determined to be outdated. The processor(s) is further configured to transmit a new SI instead of retransmitting the outdated SI.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a nodeB in communication with a UE in a telecommunications system.

FIG. 4A is a call flow illustrating a scheduling request procedure pursuant to time division-high speed uplink packet access.

FIG. 4B is another call flow illustrating a scheduling request procedure pursuant to time division-high speed uplink packet access.

FIG. 4C is a call flow illustrating an improved scheduling request retransmission procedure according to some aspects of the present disclosure.

FIG. 5 is a block diagram illustrating a wireless communication method for a scheduling request procedure according to some aspects of the present disclosure.

FIG. 6 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

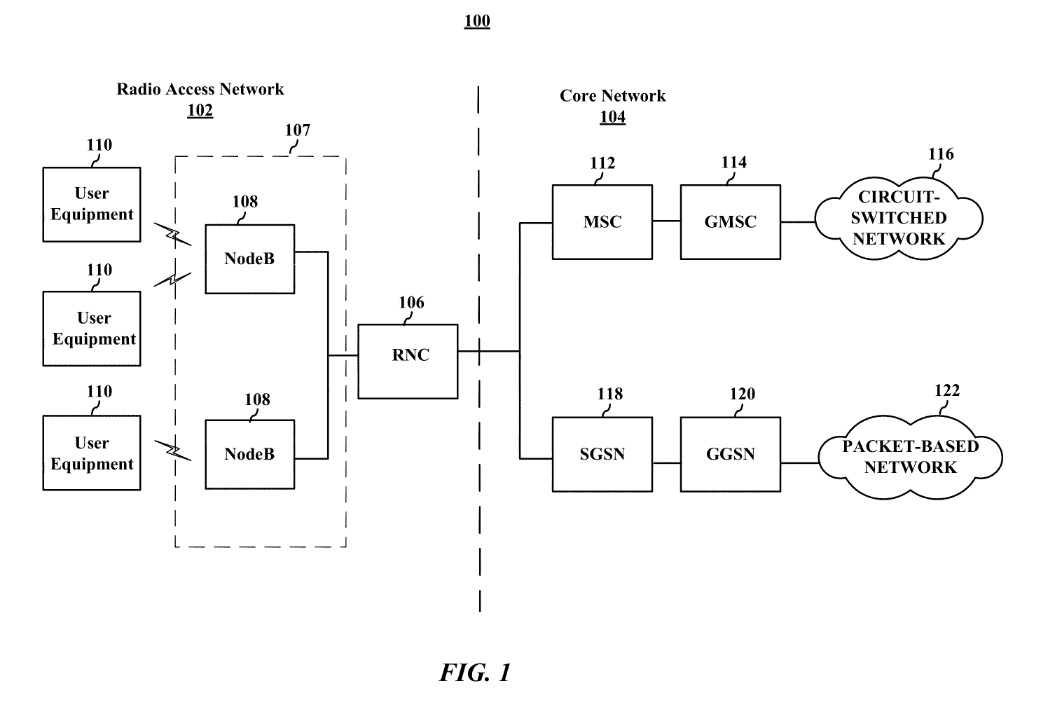

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 108 are shown; however, the RNS 107 may include any number of wireless nodeBs. The nodeBs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the nodeBs 108. The downlink (DL), also called the forward link, refers to the communication link from a nodeB to a UE, and the uplink (UL), also called the reverse link, refers to the communication link from a UE to a nodeB.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving general packet radio service (GPRS) support node (SGSN) 118 and a gateway GPRS support node (GGSN) 120. GPRS is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 108 and a UE 110, but divides uplink and downlink transmissions into different time slots in the carrier.

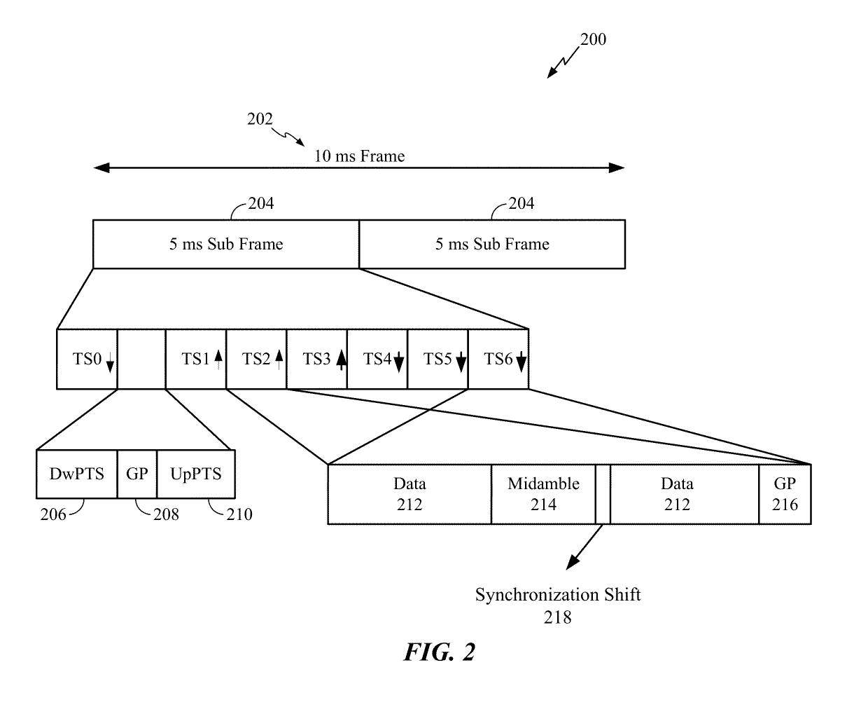

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms sub frames 204, and each of the sub frames 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

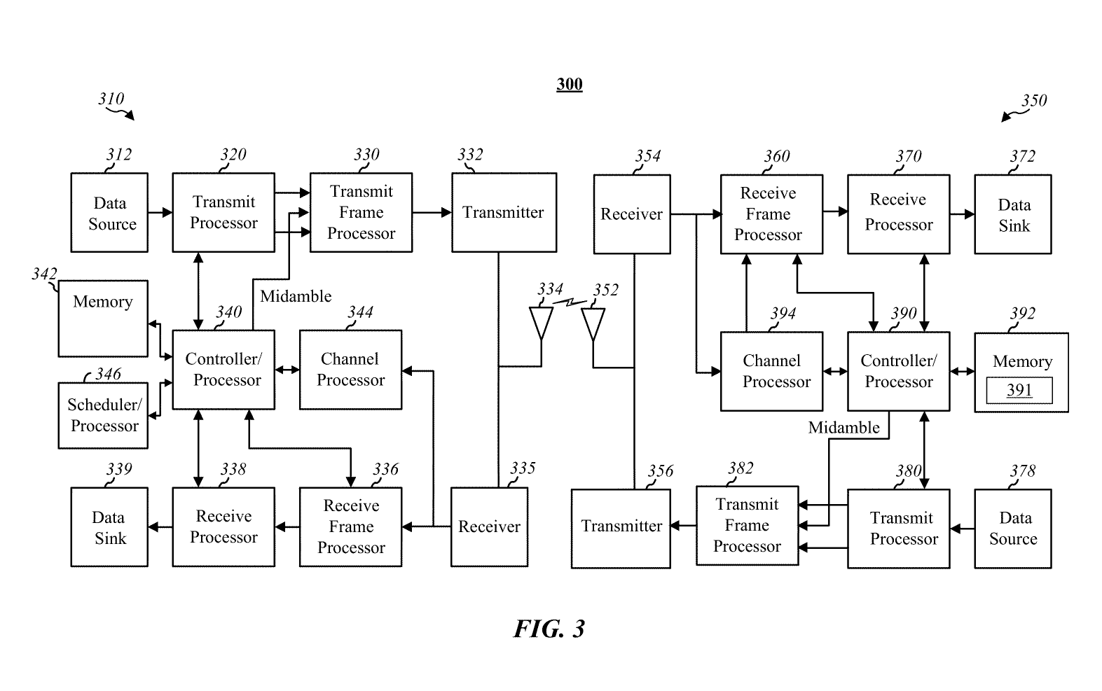

FIG. 3 is a block diagram of a nodeB 310 in communication with a UE 350 in a RAN 300, where the RAN 300 may be the RAN 102 in FIG. 1, the nodeB 310 may be the nodeB 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the nodeB 310. More specifically, the receive processor 370 descrambles and despreads the symbols, and then determines the most likely signal constellation points transmitted by the nodeB 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the nodeB 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the nodeB 310 or from feedback contained in the midamble transmitted by the nodeB 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the nodeB 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the nodeB 310 and the UE 350, respectively. For example, the controller/processors 340 and 390 may provide various functions including timing, peripheral interfaces, voltage regulation, power management, and other control functions. The computer-readable media of memories 342 and 392 may store data and software for the nodeB 310 and the UE 350, respectively. For example, the memory 392 of the UE 350 may store a scheduling request module 391 which, when executed by the controller/processor 390, configures the UE 350 to perform improved scheduling information (SI) retransmission. A scheduler/processor 346 at the nodeB 310 may be used to allocate resources to the UEs and schedule downlink and/or uplink transmissions for the UEs.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and scheduling information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

In TD-HSUPA, the transmission of scheduling information (SI) may consist of in-band and out-band transmissions. The in-band type may be included in a medium access control e-type protocol data unit (MAC-e PDU) on the E-PUCH. The data may be sent standalone or may piggyback onto a data packet. For out-band, the data may be sent on the E-RUCCH. The scheduling information may include information, such as the highest priority logical channel ID (HLID), the total E-DCH buffer status (TEBS), the highest priority logical channel buffer status (HLBS) and the UE power headroom (UPH).

The HLID field identifies the highest priority logical channel with available data. If multiple logical channels exist with the highest priority, the one corresponding to the highest buffer occupancy is reported.

The TEBS field identifies the total amount of data available across all logical channels for which reporting has been requested by the radio resource control (RRC). The TEBS field also indicates the amount of data (in number of bytes) that is available for transmission and retransmission in the radio link control (RLC) layer. When the medium access control (MAC) is connected to an acknowledge mode (AM) radio link control entity, the control protocol data units (PDUs) that are to be transmitted and RLC PDUs outside the RLC transmission window are also included in the TEBS. The RLC PDUs that have been transmitted, but not negatively acknowledged by the peer entity, are not included in the TEBS. The actual value of the TEBS transmitted is one of 31 values that are mapped to a range of a number of bytes (e.g., 5 mapping to 24<TEBS<32).

The HLBS field indicates the amount of data available from the logical channel identified by the HLID. The amount of data available is relative to the highest value of the buffer size range reported by the TEBS when the reported TEBS index is not 31, and relative to 50,000 bytes when the reported TEBS index is 31. The values taken by HLBS is one of 16 values that map to a range of percentage values (e.g., 2 maps to 6%<HLBS<8%)

The UE power headroom (UPH) field indicates the ratio of the maximum UE transmission power and the corresponding dedicated physical control channel (DPCCH) code power.

The serving neighbor cell path loss (SNPL) reports the path loss ratio between the serving cell and the neighboring cells. The base station scheduler incorporates the SNPL for inter-cell interference management tasks to avoid neighbor cell overload.

### Scheduling Request Retransmission

Aspects of the disclosure are directed to an improved scheduling request retransmission procedure. The improved scheduling request procedure is described with respect to a High Speed Uplink Packet Access (HSUPA) system, such as a time division-high speed uplink packet access (TD-HSUPA) system. However, the improved scheduling request procedure may be implemented on other networks.

A scheduling request including scheduling information may be sent by a user equipment (UE) to a nodeB when the UE desires to send information (e.g., data) to the nodeB. The scheduling information (SI) is information used to coordinate scheduling of UE data transmission to a nodeB. For example, a UE may transmit scheduling information when the UE has data to send but no grant, when the UE has a grant but higher priority data arrives for which the UE desires a new grant, when the UE performs handover to a different cell or different frequency and has data to send, or when a timer expires. The scheduling information may be included in a medium access control e-type protocol data unit (MAC-e PDU) when the MAC-e PDU has sufficient room for the scheduling information to be included. As noted, the scheduling information may include information, such as the highest priority logical channel identification (HLID), the total enhanced data channel buffer status (TEBS), the highest priority logical channel buffer status (HLBS) and the UE power headroom (UPH).

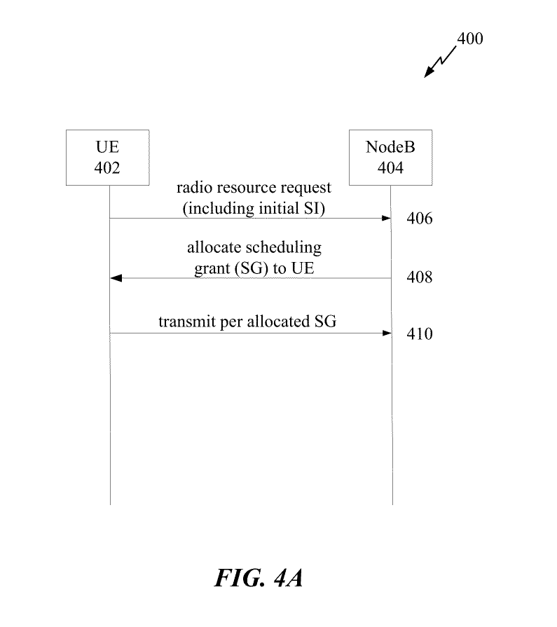

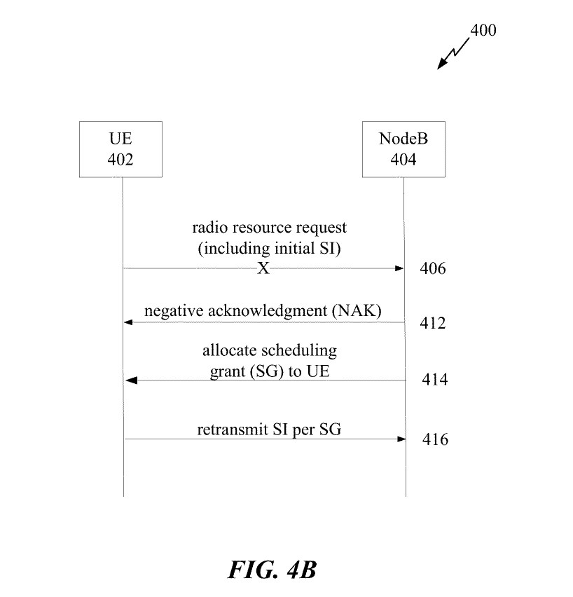

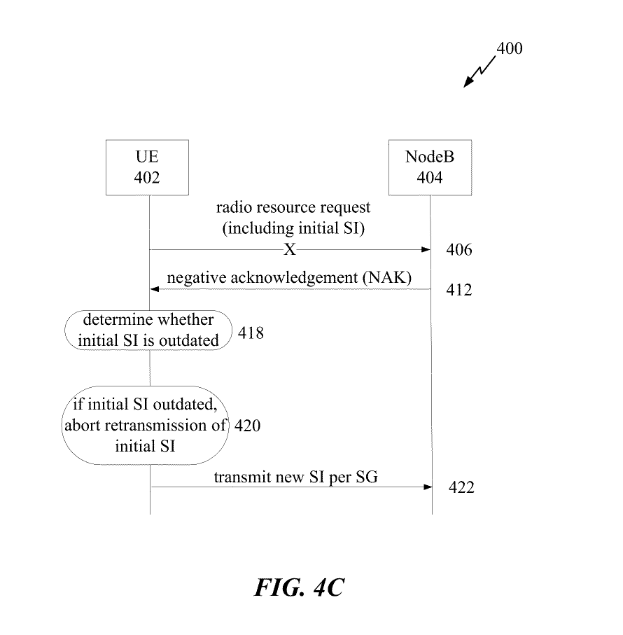

The scheduling request is transmitted on a physical channel, such as an enhanced uplink dedicated channel (E-DCH) physical uplink channel (E-PUCH) and/or an E-DCH random access uplink control channel (E-RUCCH). In some cases, a transmission error may occur for the SI transmission on the enhanced physical uplink control channel (E-PUCH). In response to the error, the UE retransmits the SI. In some cases, the SI may change between the time of the transmission error and the SI retransmission. In one aspect of the present disclosure, when the SI changes during or prior to the retransmission of the previous SI, the UE aborts the retransmission of the previous SI. The UE then transmits new SI using a radio resource (e.g., a scheduling grant) received at the time of aborting or after the time of aborting. An exemplary scheduling request procedure for uplink communications is illustrated in FIG. 4A.

FIG. 4A is a call flow diagram 400 illustrating a time division-high speed uplink packet access scheduling request procedure. At time 406, a UE 402 sends a radio resource request (for example, current scheduling information (SI)), to the nodeB 404 via E-PUCH or E-RUCCH seeking permission from the nodeB 404 to transmit on the uplink. For example, the in-band scheduling information transmissions may be included in the MAC-e PDU on the E-PUCH. The out-band scheduling information transmissions may be included on the E-RUCCH. At time 408, the nodeB 404, which controls the uplink radio resources, allocates resources to the UE 402 in the form of scheduling grants (SG) to individual UEs based on their requests. At time 410, the UE 402 transmits on the uplink after receiving grants from the nodeB 404.

Hybrid automatic repeat request (HARQ) procedures may be employed for rapid retransmission of improperly received data packets (including the current scheduling information) between the UE 402 and nodeB 404. For example, a negative acknowledgment may be transmitted to the UE 402 if the nodeB 404 does not receive the current scheduling information during a predetermined time period, as illustrated in FIG. 4B.

FIG. 4B is a call flow diagram 400 illustrating a scheduling request procedure pursuant to time division-high speed uplink packet access. Similar to the scheduling request procedure of FIG. 4A, the UE 402 sends a radio resource request to the nodeB 404 via E-PUCH or E-RUCCH at time 406. In some instances, the radio resource request, including the current scheduling information may be improperly received (i.e., received erroneously or failed to receive). As noted, Hybrid automatic repeat request (HARQ) procedures may be employed for rapid retransmission of improperly received current scheduling information. For example, at time 412, the UE 402 receives a negative acknowledgment (NAK) indicating that the current scheduling information was not received or was erroneously received. The negative acknowledgment may be caused by a transmission error during transmission of the current scheduling information on the E-PUCH or E-RUCCH.

The reception of the negative acknowledgment causes the UE 402 to retransmit the current scheduling information at time 416. According to this scheduling request procedure, the current scheduling information may be retransmitted regardless of whether the current scheduling information is outdated. For each retransmission, however, the UE 402 waits for a grant (e.g., new SG at time 414) to retransmit the current scheduling information. The new grant may or may not be allocated for the retransmission of the current scheduling information. In some specifications, the number of time slots in the new grant has to be the same as the number of time slots in the current E-PUCH transmission. Waiting for a new grant to satisfy this specification in retransmission of the current scheduling information.

In some instances, the scheduling information may change between the time of the transmission error and the scheduling information retransmission. For example, the changed information may include buffer size, power headroom, serving and neighbor cell path loss, and highest priority Logical channel ID. The change in the scheduling information prior to or during retransmission of the current scheduling information causes the current scheduling information to be invalid or outdated. Although the current scheduling information is outdated, the UE has to wait for successful delivery of the current scheduling information before transmitting new scheduling information. In some instances, the UE waits for a maximum allowed retransmission timer to expire or until the UE achieves a maximum allowed retransmission before transmitting the new scheduling information. The delay in transmitting the new scheduling information negatively affects communication throughput between the UE and the nodeB.

Various aspects of the present disclosure are directed to an improved scheduling request procedure. In one aspect of the present disclosure, when the scheduling information changes prior to or during a current scheduling information retransmission, the current scheduling information becomes outdated. As a result, the UE aborts the retransmission of the current scheduling information and initiates a new scheduling information transmission using the received grant. The grant may be received prior to or at the time of aborting. As noted, the grant may not be specifically allocated for the new scheduling information. The UE decides whether to transmit the new scheduling information on the received grant.

The changed information may include a buffer size change that is more than a threshold amount, a power headroom change that is more than a threshold amount, and/or a serving neighbor cell path loss (SNPL) change that is greater than a threshold amount. Other examples of changed SI include a UE highest priority logical channel change due to a presence of data and/or a UE highest priority logical channel buffer status change that is greater than a threshold amount.

In some aspects, based on the grant (e.g., size of grant) and current UE power headroom, in addition to transmitting new scheduling information, the UE transmits one or more radio link control (RLC) protocol data units (PDUs) that were transmitted with the old SI. For example, the UE retransmits an old protocol data unit (PDU) with the new SI when the old PDU was aborted along with the retransmission of the current SI. In other aspects, the UE transmits a new PDU with the new SI when no PDUs were aborted along with the retransmission of the current SI.

An exemplary improved scheduling request procedure is illustrated in FIG. 4C. FIG. 4C is a call flow diagram 400 illustrating an improved scheduling request procedure using a physical uplink channel, such as E-RUCCH or E-PUCH. In particular, the scheduling request procedure of FIG. 4C is an improved scheduling request procedure relative to the scheduling request procedure illustrated in FIGS. 4A and 4B. For example, the improved scheduling request procedure of FIG. 4C includes a different process after the erroneous transmission of the current scheduling information. When the UE 402 is informed of or determines the erroneous transmission of the current scheduling information, the UE observes whether the current scheduling information is outdated. For example, at time 418, the UE determines that the current scheduling information is outdated. In some instances, the UE is aware of the erroneous transmission of the scheduling information based on the reception of the negative acknowledgment at time 412.

If the current scheduling information is outdated, the UE aborts the retransmission of the current scheduling information as illustrated at time 420. Instead, the UE transmits new scheduling information using a grant received at the time of aborting. The new scheduling information is transmitted at time 422. In some aspects, the new scheduling information is transmitted prior to the expiration of the retransmission timer and/or before the maximum allowed retransmission.

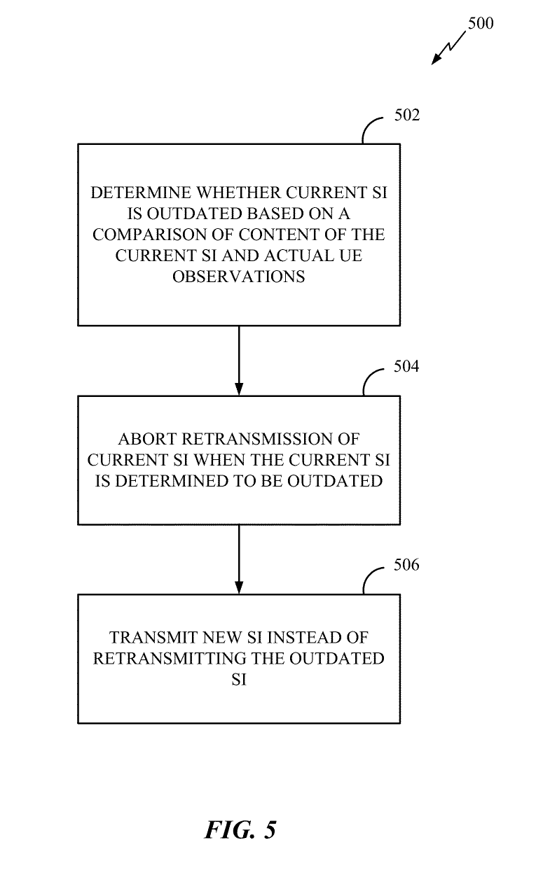

FIG. 5 is a block diagram illustrating a wireless communication method 500 for a scheduling request procedure according to aspects of the present disclosure. In block 502, a UE determines whether current scheduling information (SI) is outdated based on a comparison of content of the current SI and actual UE observations. In block 504, the UE aborts a retransmission of the current SI when the current SI is determined to be outdated. In block 506, the UE transmits new SI instead of retransmitting the outdated SI.

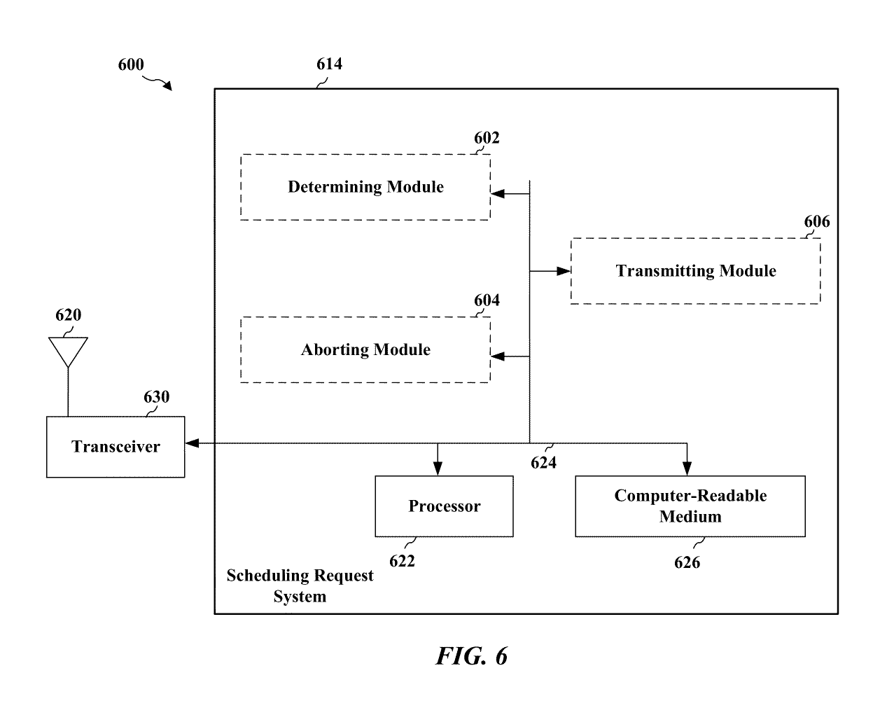

FIG. 6 is a diagram illustrating an example of a hardware implementation for an apparatus 600 employing a scheduling request system 614. The scheduling request system 614 may be implemented with a bus architecture, represented generally by the bus 624. The bus 624 may include any number of interconnecting buses and bridges depending on the specific application of the scheduling request system 614 and the overall design constraints. The bus 624 links together various circuits including one or more processors and/or hardware modules, represented by the processor 622, the determining module 602, the aborting module 604, the transmitting module 606, and the computer-readable medium 626. The bus 624 may also link various other circuits such as timing sources, peripherals, voltage regulators, and power management circuits, which are well known in the art, and therefore, will not be described any further.

The apparatus includes a scheduling request system 614 coupled to a transceiver 630. The transceiver 630 is coupled to one or more antennas 620. The transceiver 630 enables communicating with various other apparatus over a transmission medium. The scheduling request system 614 includes a processor 622 coupled to a computer-readable medium 626. The processor 622 is responsible for general processing, including the execution of software stored on the computer-readable medium 626. The software, when executed by the processor 622, causes the scheduling request system 614 to perform the various functions described for any particular apparatus. The computer-readable medium 626 may also be used for storing data that is manipulated by the processor 622 when executing software.

The scheduling request system 614 includes a determining module 602 for determining whether current SI is outdated based on a comparison of content of the current SI and actual UE observations. The scheduling request system 614 also includes an aborting module for aborting a retransmission of the current SI when the current SI is determined to be outdated. The scheduling request system 614 also includes a transmitting module for transmitting new SI instead of retransmitting the outdated SI. The modules may be software modules running in the processor 622, resident/stored in the computer-readable medium 626, one or more hardware modules coupled to the processor 622, or some combination thereof. The scheduling request system 614 may be a component of the UE 350 and may include the memory 392, and/or the controller/processor 390.

In one configuration, an apparatus, such as an UE 350, is configured for wireless communication including means for determining. In one aspect, the above means may be the receive processor 370, the transmit processor 380, the controller/processor 390, the memory 392, the antenna 352, 620, the receiver 354, the transmitter 356, the transceiver 630, the scheduling request module 391, the determining module 602, the processor 622, and/or the scheduling request system 614 configured to perform the functions recited by the aforementioned means. In another aspect, the aforementioned means may be any module or any apparatus configured to perform the functions recited by the aforementioned means.

In one configuration, the apparatus configured for wireless communication also includes means for aborting. In one aspect, the above means may be the antenna 352, the transmitter 356, the transmit processor 380, the controller/processor 390, the memory 392, the scheduling request module 391, the aborting module 604, the processor 622, and/or the scheduling request system 614 configured to perform the functions recited by the aforementioned means. In another aspect, the aforementioned means may be any module or any apparatus configured to perform the functions recited by the aforementioned means.

In one configuration, the apparatus configured for wireless communication also includes means for transmitting. In one aspect, the above means may be the antenna 352, the transmitter 356, the transmit processor 380, the controller/processor 390, the memory 392, the scheduling request module 391, the transmitting module 606, the processor 622, and/or the scheduling request system 614 configured to perform the functions recited by the aforementioned means. In another aspect, the aforementioned means may be any module or any apparatus configured to perform the functions recited by the aforementioned means.

Several aspects of a telecommunications system has been presented with reference to TD-SCDMA systems and/or TD-HSUPA. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing global system for mobile communications (GSM), long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether current scheduling information (SI) is outdated based at least in part on a comparison of content of the current SI and actual user equipment (UE) observations;
aborting a retransmission of the current SI when the current SI is determined to be outdated; and
transmitting new SI instead of retransmitting the outdated SI.

2. The method of claim 1, in which the UE observations include UE transmit buffer size, UE power headroom, serving and neighbor cell path loss (SNPL) and/or UE highest priority logical channel identification with data in a buffer of the UE.

3. The method of claim 1, in which the current SI is outdated when:
a UE transmit buffer size change is greater than a first threshold;
a UE power headroom change is greater than a second threshold;
a serving neighbor cell path loss (SNPL) ratio change is greater than a third threshold;
a UE highest priority logical channel change due to presence of data; and/or
a UE highest priority logical channel buffer status change is greater than a fourth threshold.

4. The method of claim 1, further comprising retransmitting old protocol data units (PDUs) with the new SI when the old PDUs were aborted along with the outdated SI.

5. The method of claim 1, further comprising transmitting new PDUs with the new SI when no PDUs were aborted along with the outdated SI.

6. An apparatus for wireless communication, comprising:
means for determining whether current scheduling information (SI) is outdated based at least in part on a comparison of content of the current SI and actual user equipment (UE) observations;
means for aborting a retransmission of the current SI when the current SI is determined to be outdated; and
means for transmitting new SI instead of retransmitting the outdated SI.

7. The apparatus of claim 6, in which the UE observations include UE transmit buffer size, UE power headroom, serving and neighbor cell path loss (SNPL) and/or UE highest priority logical channel identification with data in a buffer of the UE.

8. The apparatus of claim 6, in which the current SI is outdated when:
a UE transmit buffer size change is greater than a first threshold;
a UE power headroom change is greater than a second threshold;
a serving neighbor cell path loss (SNPL) ratio change is greater than a third threshold;
a UE highest priority logical channel change due to a presence of data; and/or
a UE highest priority logical channel buffer status change is greater than a fourth threshold.

9. The apparatus of claim 6, further comprising means for retransmitting old protocol data units (PDUs) with the new SI when the old PDUs were aborted along with the outdated SI.

10. The apparatus of claim 6, further comprising means for transmitting new PDUs with the new SI when no PDUs were aborted along with the outdated SI.

11. An apparatus for wireless communication, comprising:
a memory; and
at least one processor coupled to the memory and configured:
to determine whether current scheduling information (SI) is outdated based at least in part on a comparison of content of the current SI and actual user equipment (UE) observations;
to abort a retransmission of the current SI when the current SI is determined to be outdated; and
to transmit new SI instead of retransmitting the outdated SI.

12. The apparatus of claim 11, in which the UE observations include UE transmit buffer size, UE power headroom, serving and neighbor cell path loss (SNPL) and/or UE highest priority logical channel identification with data in a buffer of the UE.

13. The apparatus of claim 11, in which the current SI is outdated when:
a UE transmit buffer size change is greater than a first threshold;
a UE power headroom change is greater than a second threshold;
a serving neighbor cell path loss (SNPL) ratio change is greater than a third threshold;
a UE highest priority logical channel changes due to a presence of data; and/or
a UE highest priority logical channel buffer status change is greater than a fourth threshold.

14. The apparatus of claim 11, in which the at least one processor is further configured to retransmit old protocol data units (PDUs) with the new SI when the old PDUs were aborted along with the outdated SI.

15. The apparatus of claim 11, in which the at least one processor is further configured to transmit new PDUs with the new SI when no PDUs were aborted along with the outdated SI.

16. A computer program product for wireless communications in a wireless network, comprising:
a non-transitory computer-readable medium having program code recorded thereon, the program code comprising:
program code to determine whether current scheduling information (SI) is outdated based at least in part on a comparison of content of the current SI and actual user equipment (UE) observations;
program code to abort a retransmission of the current SI when the current SI is determined to be outdated; and
program code to transmit new SI instead of retransmitting the outdated SI.

17. The computer program product of claim 16, in which the UE observations include UE transmit buffer size, UE power headroom, serving and neighbor cell path loss (SNPL) and/or UE highest priority logical channel identification with data in a buffer of the UE.

18. The computer program product of claim 16, in which the current SI is outdated when:
a UE transmit buffer size change is greater than a first threshold;
a UE power headroom change is greater than a second threshold;
a serving neighbor cell path loss (SNPL) ratio change is greater than a third threshold;
a UE highest priority logical channel changes due to a presence of data; and/or
a UE highest priority logical channel buffer status change is greater than a fourth threshold.

19. The computer program product of claim 16, further comprising program code to retransmit old protocol data units (PDUs) with the new SI when the old PDUs were aborted along with the outdated SI.

20. The computer program product of claim 16, further comprising program code to transmit new PDUs with the new SI when no PDUs were aborted along with the outdated SI.
